(19) United States
(12) Patent Application Publication
(10) Pub. No.: US 2013/0282210 A1
(43) Pub. Date: Oct. 24, 2013

(54) UNMANNED MARITIME VEHICLE WITH INFERENCE ENGINE AND KNOWLEDGE BASE AND RELATED METHODS

(71) Applicants: Ray KOLAR, Grant, FL (US); Patrick MEHARG, Merritt Island, FL (US)

(72) Inventors: Ray KOLAR, Grant, FL (US); Patrick MEHARG, Merritt Island, FL (US)

(73) Assignee: HARRIS CORPORATION, Melbourne, FL (US)

(21) Appl. No.: 13/454,762

(22) Filed: Apr. 24, 2012

(51) Int. Cl. G05D 1/02

(52) U.S. Cl. 701/21

(57) ABSTRACT

An unmanned maritime vehicle includes a hull, a propulsion system carried by the hull, vehicle sensors carried by the hull, a wireless transceiver carried by the hull, and a controller coupled to the wireless transceiver, the vehicle sensors, and the propulsion system. The controller is configured to implement an inference engine and a knowledge base to define an expert system generating a recommended water navigational action based upon a set of water navigational rules and inputs from the vehicle sensors.

### FIELD OF THE INVENTION

The present invention relates to the field of unmanned vehicles, and, more particularly, to an unmanned maritime vehicle and related methods.

### BACKGROUND OF THE INVENTION

Depending on the maritime application, there is a plurality of different vehicles that may be deployed. For example, these vehicles may include manned vessels, buoy devices, and unmanned maritime vehicles, such as unmanned maritime vehicles (UMVs). The manned vessel is the most capable and versatile ocean faring vehicle available. Nevertheless, the manned vessel has several drawbacks, such as that they are more expensive to operate and subject personnel to typical ocean faring risks.

The UMV provides a desirable compromise between the manned vessel and the buoy device. In particular, the UMV provides much of the capability available from a manned vessel with lower costs, and without risk to personnel. Because of these features, the UMV has become popular for certain oceanographic applications, such as surveying, etc., and for surveillance applications for governments and private organizations.

When using manned vessels or UMVs, the navigation of these vehicles is critical to their successful use. Indeed, the most capable vessel is incapacitated or destroyed when it runs aground or impacts another vehicle. Maritime collisions have occurred since the first vessels sailed the seas, but with the advancement of UMVs, some approaches have used near autonomous control systems. The International Regulations for Preventing Collisions at Sea (COLREGS) are published by the International Maritime Organization (IMO) to establish the “rules of the road” to be followed by ships and other vessels at sea.

One approach is disclosed in U.S. Patent Application Publication No. 2011/0288714 to Flohr et al. Flohr et al. discloses an automated method for autonomous navigation of a UMV. The method includes using a plurality of navigational sensors, and a plurality of environmental sensors to identify obstacles in the vicinity of the UMV. The UMV includes a decision module for choosing a course and speed based upon the sensor data.

### SUMMARY OF THE INVENTION

In view of the foregoing background, it is therefore an object of the present invention to provide an unmanned maritime vehicle that is more readily controlled.

This and other objects, features, and advantages in accordance with the present invention are provided by an unmanned water vehicle comprising a hull, a propulsion system carried by the hull, a plurality of vehicle sensors carried by the hull, a wireless transceiver carried by the hull and configured to communicate with a command center, and a controller coupled to the wireless transceiver, the plurality of vehicle sensors, and the propulsion system. The controller is configured to implement an inference engine and a knowledge base to define an expert system generating a recommended water navigational action based upon a set of water navigational rules and inputs from the plurality of vehicle sensors. Advantageously, an operator of the unmanned maritime vehicle may control the vehicle using the recommended water navigational action.

More specifically, the controller may be configured to implement the expert system to generate the recommended water navigational action by matching at least one water navigational rule from the set thereof to the inputs from the plurality of vehicle sensors. The controller may be configured to implement the expert system to match a plurality of water navigational rules to the inputs of the plurality of vehicle sensors, and to resolve conflicts among the matching plurality of water navigational rules to provide the recommended navigational action. Each water navigational rule may include a respective priority value, and the controller may be configured to implement the expert system to resolve the conflicts among the matching plurality of water navigational rules based upon the respective priority values thereof.

Another aspect is directed to a method for operating an unmanned maritime vehicle comprising a hull, a propulsion system carried by the hull, a plurality of vehicle sensors carried by the hull, and a wireless transceiver carried by the hull. The method includes implementing an inference engine and a knowledge base to define an expert system generating a recommended water navigational action based upon a set of water navigational rules and inputs from the plurality of vehicle sensors.

### BRIEF DESCRIPTION OF THE DRAWINGS

FIG. 1 is a schematic diagram of an unmanned maritime vehicle, according to the present invention.

FIG. 2 is a flowchart illustrating operation of the unmanned maritime vehicle of FIG. 1.

FIG. 3 is a schematic diagram of another embodiment of the unmanned maritime vehicle, according to the present invention.

FIG. 4 is a flowchart illustrating operation of the unmanned maritime vehicle of FIG. 3.

FIG. 5 is a schematic diagram of the control unit from the unmanned maritime vehicle of FIG. 3.

FIG. 6 is a diagram illustrating an operation scenario for the unmanned maritime vehicle of FIG. 3.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

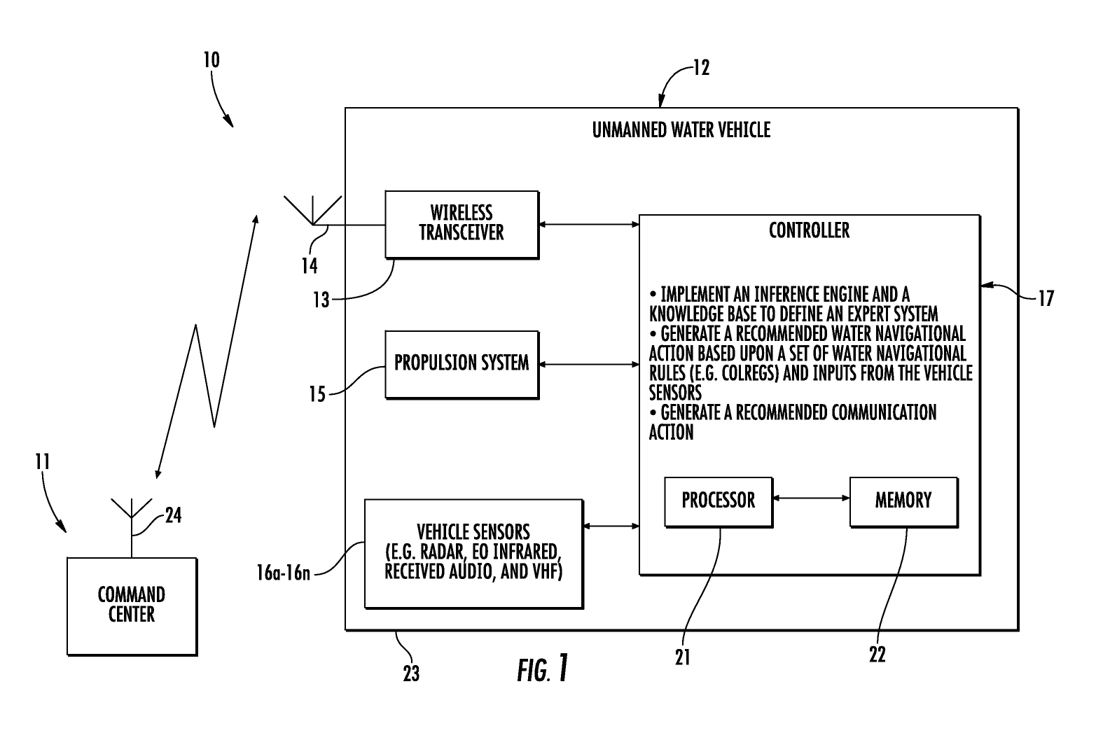

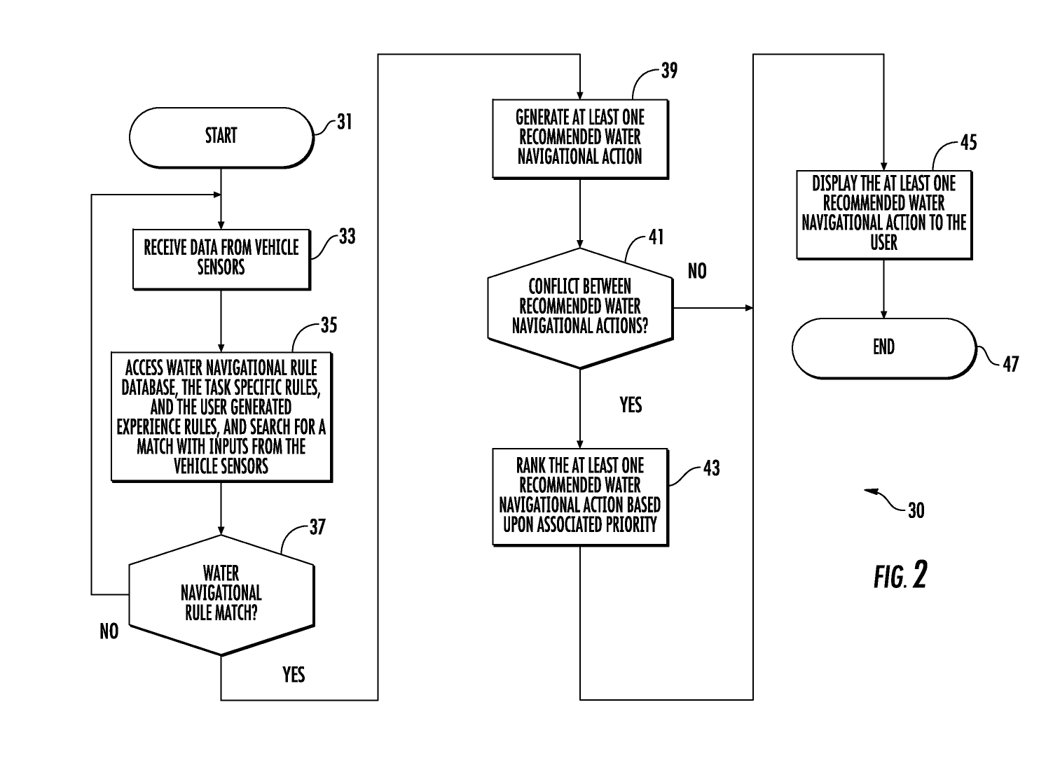

Referring initially to FIGS. 1-2, an unmanned maritime vehicle system 10 according to the present invention is now described, and with reference to flowchart 30, a method for operation of the unmanned maritime vehicle system is also now described (Block 31). The unmanned maritime vehicle system 10 includes an unmanned maritime vehicle 12, and a command center 11 in communication therewith. The unmanned maritime vehicle 12 may comprise an underwater submersible vehicle that may require navigation at the surface, a semisubmersible unmanned vehicle, and/or a unmanned surface vehicle, such as a UMV. In particular, the command center 11 illustratively includes an antenna 24, and may include one or more operators therein for remotely controlling the unmanned maritime vehicle 12 via transmissions with the local antenna.

The unmanned maritime vehicle system 10 includes an unmanned maritime vehicle 12 comprising a hull 23, and a propulsion system 15 carried by the hull. The propulsion system 15 may comprise a motorized propeller, for example.

The unmanned maritime vehicle system 10 includes a plurality of vehicle sensors 16a-16n carried by the hull. The plurality of vehicle sensors 16a-16n may comprise at least one of a RADAR vehicle sensor, an EO infrared vehicle sensor, a received audio sensor, and a VHF vehicle communications. The plurality of vehicle sensors 16a-16n provide an environmental look about the unmanned vehicle 12 (Block 33) for the one or more operators at the command center 11. Furthermore, the unmanned maritime vehicle system 10 includes a wireless transceiver 13 carried by the hull, and an antenna 14 coupled to the wireless transceiver for receiving and transmitting signals with the command center 11.

The unmanned maritime vehicle system 10 includes a controller 17 coupled to the wireless transceiver 13, the plurality of vehicle sensors 16a-16n, and the propulsion system 15. In particular, the controller 17 comprises a central processing unit (CPU) and is configured to control operations of the unmanned maritime vehicle 12 based upon over the air instructions received from the one or more operators at the command center 11.

The controller 17 is configured to implement an inference engine and a knowledge base to define an expert system generating a recommended water navigational action based upon a set of water navigational rules and inputs from the plurality of vehicle sensors 16a-16n (Block 35). Additionally, the expert system may receive the inputs from the plurality of vehicle sensors 16a-16n comprising current and past vehicle sensor data values.

For example, the set of water navigational rules may comprise rules based upon the COLREGS. Moreover, in some embodiments, the expert system may generate the recommended water navigational action based upon a set of task specific rules, i.e. mission guidelines/goals, and/or a set of user generated experience rules. For example, the user generated experience rules may be derived from unique operational experience from significant use of the unmanned maritime vehicle 12. Each water navigational rule may include a respective priority value, thereby providing an ordered hierarchy in the rule base.

More specifically, the expert system may generate the recommended water navigational action by matching one or more water navigational rules from the set thereof to the inputs from the plurality of vehicle sensors 16a-16n (Blocks 37, 39). In instances where there are more than one matching rule and where those rules conflict in recommend action (Block 41), such as recommending differing course changes, the expert system resolves conflicts among the matching water navigational rules to provide the recommended navigational action by ranking proposed recommend navigational actions based upon the respective priority values of the rules they are based upon (Block 43), i.e. the recommended action coming from the higher ranked rule prevails.

In some embodiments, the expert system may generate a recommended communication action based upon a set of water navigational rules and inputs from the plurality of vehicle sensors 16a-16n. For example, if before taking a recommended course change, the COLREGS require hailing of a nearby vessel, the expert system would recommend the proper associated communication action in conjunction with the recommend water navigational action. In some embodiments, the controller 17 cooperates with the wireless transceiver 13 to perform the recommend communication action, i.e. the unmanned maritime vehicle 12 would automatically perform the communication action, such as hailing the nearby vessel on VHF, without further input from the one or more operators. In some embodiments, the unmanned maritime vehicle 12 includes an audio indicator, such as a horn, and the controller 17 activates the horn to perform the recommended communication action.

While the one or more operators at the command center 24 operate the unmanned maritime vehicle 12, the controller 17 cooperates with the wireless transceiver 13 to transmit the recommended water navigational/communication action to the command center 11. At the command center 11, the recommended water navigational action and/or the recommended communication action is presented to the one or more operators, who can then choose whether to implement the recommended water navigational/communication action (Blocks 45, 47).

Advantageously, the one or more operators at the command center 11 can control the unmanned maritime vehicle 12 more adeptly. In short, a novice operator, without good knowledge of the COLREGS, for example, can operate the unmanned maritime vehicle 12 as well as an experienced operator since proper course actions with respect to other vessels will be automatically presented to the operator. Moreover, experience based information is made part of the rule base used by the inference engine, thereby giving the novice operator some advantages that the experienced operator would have.

Another aspect is directed to a control unit 17 for an unmanned maritime vehicle 12 comprising a hull 13, a propulsion system 15 carried by the hull, a plurality of vehicle sensors 16a-16n carried by the hull, and a wireless transceiver 13 carried by the hull. The control unit 17 comprises a processor 21 and a memory 22 associated therewith and being configured to implement an inference engine and a knowledge base to define an expert system generating a recommended water navigational action based upon a set of water navigational rules and inputs from the plurality of vehicle sensors 16a-16n.

Another aspect is directed to a method for operating an unmanned maritime vehicle 12 comprising a hull 23, a propulsion system 15 carried by the hull, a plurality of vehicle sensors 16a-16n carried by the hull, and a wireless transceiver 13 carried by the hull. The method includes implementing an inference engine and a knowledge base to define an expert system generating a recommended water navigational action based upon a set of water navigational rules and inputs from the plurality of vehicle sensors 16a-16n.

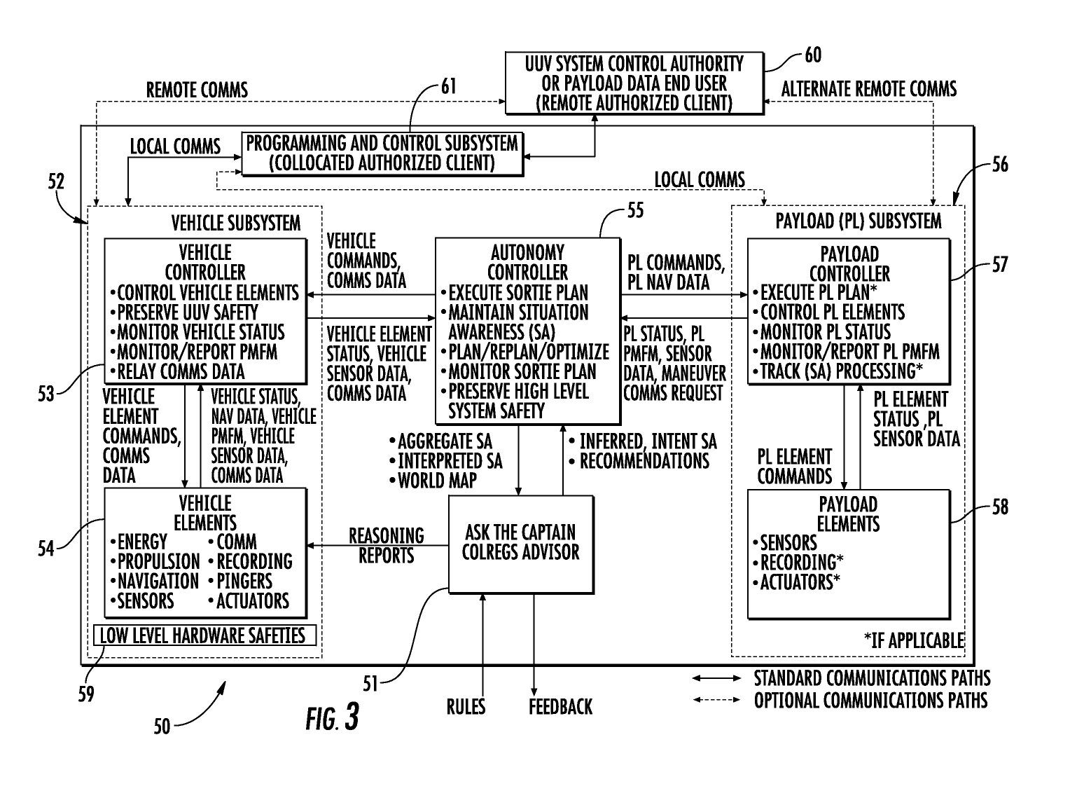

Referring now to FIG. 3, as will be appreciated by those skilled in the art, an exemplary implementation 50 of the unmanned maritime vehicle 12 is illustrated. The implementation 50 illustratively includes a vehicle subsystem block 52 comprising a vehicle controller 53, a plurality of vehicle elements 54 cooperating therewith, and a low level hardware safety block 59. The implementation 50 illustratively includes an autonomy controller 55, an Ask The Captain™ (ATC) block 51 coupled thereto, a programming and control block 61 coupled to the vehicle subsystem block 52, and a unmanned maritime vehicle (UMV) system control block 60 coupled thereto. The implementation 50 illustratively includes a payload subsystem 56 coupled to the autonomy controller 55 and comprising a payload controller 57, and payload elements 58 coupled thereto.

ATC is a rule-based Expert System performing the function of COLREGS advisor for maritime surface autonomy applications. COLREGS refers to the International Regulations for Preventing Collisions at Sea. They are published by the International Maritime Organization (IMO) and define the “rules of the road” to be followed by ships and other vessels at sea, including unmanned maritime vessels

The disclosed COLREGS advisor is an important component of the UMV surface autonomy controller, but is not meant to replace existing or planned capabilities, such as CARACaS, MOAA, MOOS/IvP, IC, 4D/RCS or other potential autonomy controllers based on these architectures or approaches. Rather, ATC performs a single important function, common to all surface autonomy controllers and architectures, and can be readily integrated into these controllers and a variety of vehicle architectures. ATC may provide optimal maneuvering recommendations in the presence of vessel activity and obstacles.

ATC is a rule based expert system, based on the accepted Java Expert System Shell (Jess) and tool. Because it is Java-based, ATC is a platform independent component. It can operate as a standalone component in a low power processor, or as a software component within an existing component, reducing energy consumption. Once developed, UMV ATC software remains stable, and can be rigidly controlled. The intelligence of ATC lays in its rule set, a transportable XML data base that is readily maintained outside of the UMV software. The rules are loaded prior to a task.

As rules change based on learning (analyzing post-mission performance, and examination of the ATC generated reasoning reports), the base software within the UMV does not change—only the transportable XML, or other formatted, set of rules are modified. ATC software is modular, thereby avoiding costly modifications to in-line “spaghetti” code when inevitable changes are required. Research software code that has been developed over time, usually by multiple personnel, may be extremely difficult to maintain. Modifications to this type of software based on simulation, testing and/or real world experience may require an in depth understanding of the underlying signal processing code, and access to the developers of the code. Using an expert system, and placing the intelligence (rules) in detached, easily transported rule modules, organized by rule function, may mitigate this problem. The rule modules are compact, XML (or other structured formatted) representations of the vehicle's intelligence. They can be upgraded in-situ over narrow band satellite communications links.

Typical UMVs can be difficult vehicles to control, and require high levels of user interaction. Increased autonomy decreases the need for those high skill levels, and simplifies managing-controlling the unmanned vessel. ATC supports this reduction in user skill level by addressing COLREGS requirements, including the use of rules based on experienced mariner skills. Additional support for achieving this goal is provided by ATCs English language reasoning reports, published for use by shore side personnel to better understand the vessel's situation.

ATC's capability to reduce the required operator skill level is an important feature. Once the expert mariner's knowledge is captured in the rules and verified, future UMV manpower needs are reduced. The skill level of UMV shore side operators may be significantly reduced.

The English-language reasoning reports also provide a natural interaction with the vessel. Because of the low data volume of the reports, they can be transmitted via low bandwidth satellite communications links. This operator assistance to the UMV is important as the UMV progresses to a fielded system. Even when fielded, there will be situations that call for operator assistance. The English language reasoning reports support this capability.

Increased interaction between manned and unmanned vessels is desired. ATC supports this goal by enabling the UMV to operate in complex ocean environments and high traffic locations, as well as transit in open ocean, when on the surface. Rule modules within ATC, comprising a basic COLREGS rule module combined with the rules created from experienced mariners, enables this capability. Dynamic levels of autonomy are desired, depending upon the situational environment. ATC supports this goal by attaching confidence factors to it's recommendations. Confidence factors can be assessed by the primary autonomy controller in determining the requisite level of current autonomy required.

Integration is simplified by using a standard Service Oriented Architecture (SOA) publish/subscribe interface. The standard interface allows autonomy controller developers to easily access ATC functionality, and ATC includes a personality module that allows building a nonstandard data interface if required.

This disclosure includes the objective among others to aid in compliance with COLREGS rules. Inherent in this compliance is the use of experts' knowledge in seamanship to avoid obstacles and collisions. Additional rule modules can be considered in the future, including support for task specific considerations (tactics, techniques and procedures (TTPs)), or other functions required by the autonomy controller.

Additional outboard applications are described in this disclosure that simplify the creation of rules, one of the more difficult challenges of applying rule-based expert systems to real world applications. Dynamic scenarios can be created, and assessed by domain experts (expert mariners). Their knowledge can be captured and rules created based on their knowledge. This may avoid the difficulties of modifying “in line” procedural code contained within, for example, the primary autonomy controller.

As experience, and knowledge, is gained, this information will be fed back as modified and/or new rules. ATC supports this capability by generating “English Language” reasoning reports. These reports provide a rationale for the recommendations made by ATC, and can be applied to assess ongoing mission performance, or to support performance improvements (rule creation, modification).

Since ATC can be part of multiple overall autonomy control functions, the construction of multiple ATC units, each packaged in a small low power ruggedized module, for integration by the primary autonomy controller builders.

Potential features and benefits of the ATC COLREGS Advisor include: addresses a single part of autonomy COLREGS compliance and collision avoidance, a common problem to many surface autonomy controllers; a contained, well defined problem set reduces development risk; allows autonomy control developers to focus on other key aspects of executing plan, maintaining situational awareness (SA), monitoring and optimizing performance; and this decoupling reduces risk to the autonomy control development activities.

Features include external interfaces using a SOA, specifically, a publish-subscribe interface. This provides standard interface and platform independence. Feature include using ASTM F2595 recommended data Formats, which provide platform independent, for any platform, conformance to ASTM interfaces.

Features include use of JESS, which permits use of a proven expert system development environment. Features include that ATC is a rule based expert system, which allows for the COLREGS rules to be easily represented, expert mariners knowledge to be captured, a declarative architecture vs. procedural, simplifying development and increasing execution time, and addition of modules as SA sensors provide additional information (e.g. fishnet detection and avoidance, subsea obstacle avoidance).

Features include maintaining the rules external to the UMV software, which provide for improved SW maintenance with no impact to controlled SW as experience improves knowledge base. Features include the use of JAVA software for the expert system and other required functions, which provides for processor independence, i.e. ATC can run on independent processor, or as module in existing autonomy controllers. Features include scenario generator with GUI, and Rule Maker applications (external to UMV), which allows for easy capture of expert mariners knowledge and for translation of operator input to an XML rule set—easily transported for use by all ATC modules.

The ATC creates English language reasoning reports to justify its recommendations, which allows for post-simulation, post-mission analysis, and feedback for modification/addition of rules, and reports that can be easily transported over limited bandwidth communications systems to shore side controllers—requests for help, or to provide a better understanding of the UMV operational situation. Another feature includes providing simulation tools that use actual software that would be deployed on UMV. This feature provides for a high fidelity simulation—what you see is what you get.

### ATC's Place in the ASTM UUV Architecture

FIG. 3 is an extract from ASTM F2541 for Unmanned Underwater Vehicles (UUV). The ATC component is overlaid, showing how it can be included in the typical architecture. For clarity, ATC is shown as a separate component. To be technically correct, it is part of the Autonomy Controller function. ATC can be easily integrated within Standard Architectures. ATC supports the surface autonomy function (the Autonomy Controller shown in FIG. 3). The autonomy controller accepts SA sensor inputs from the Vehicle Elements function and maintains SA. The autonomy controller executes the Sortie Plan, and optimizes this plan over time. It provides vehicle commands to the Vehicle Controller, and status to shore side controllers via the Communications Vehicle Element.

The autonomy controller provides aggregate and interpreted SA to the ATC. Aggregate SA refers to contact reports integrated over time, i.e. tracks. Interpreted SA refers to conclusions drawn about a contact from the collected SA, for example, assumption of vessel type derived from interpretation of light pattern. World map digital nautical chart information is accessible by ATC, via the pub/sub interface, and access to the vessel's database.

Rule modules are loaded pre-task. ATC uses the rule modules (organized set of rules) to provide recommendations for vehicle action based on COLREGS, and the need to safely navigate and avoid obstacles. ATC may not consider mission constraints that may override COLREGS compliance, or dictate the need for less prudent navigation in order to satisfy mission requirements.

The recommendations are returned to the primary autonomy controller as Inferred or Intent SA, and vehicle control recommendations, for example, “slow to 5 knots, turn starboard to 90 degrees, hail vessel at bearing 010 degrees on VHF . . . .” The rules and feedback interfaces at the bottom of the diagram indicate that the rules are preloaded prior to mission execution, and that feedback (learning) can be provided post mission for rule modifications. The feedback is manual, based on UMV performance and the English-language reasoning reports generated by ATC. The low data-volume of these reports is conducive for transmission over low-bandwidth satellite communications links. The reports are well suited for assessing the vehicle's situation by shore side controllers (Blocks 56-58, 60-61).

### An “ATC Centric” View of Autonomy

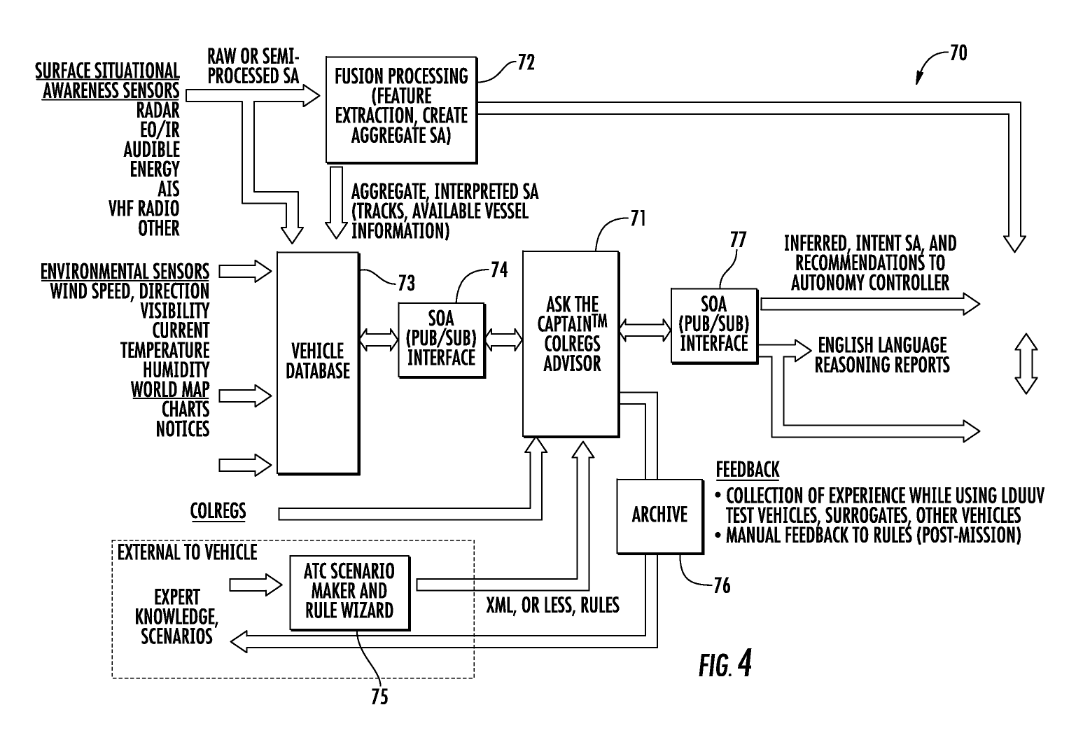

To better explain ATC's place in the autonomy function, a more “ATC-Centric” view of autonomy is illustrated in flowchart 70 of FIG. 4. The flowchart 70 illustratively includes a fusion processing block 72, and a vehicle database block 73 coupled downstream therefrom, an SOA interface 74 coupled to the vehicle database block, and an ATV advisor block 71 coupled to the SOA interface. The flowchart 70 illustratively includes an ATV scenario maker and rule wizard block 75 coupled upstream the ATC advisor block 71, an archive block 76 coupled to the ATC advisor block, and another SOA interface 77 coupled downstream from the ATC advisor block.

Referring to the upper-left of FIG. 4, a set of surface SA sensors provide raw outputs of detection events. A variety of sensor types are possible to support surface SA, all constrained by the UMV size, weight and energy constraints.

It is assumed that the surface autonomy will be used to support mission operations and transit, but not operation in crowded ports. Adding close quarters, crowded space operation places additional demands on the sensor suite. Required reaction times are significantly reduced. “Close in” sensors, such as LIDAR, will be required, significantly increasing vehicle complexity.

In terms of ATC, the above impact is less severe. ATC simply requires better SA to do its job in crowded ports, and the rule base will be more complex to accommodate more complicated constraints. There is, however, no significant impact to ATC. Rules are added as the improved sensors become available. Analysis will be performed to ensure that sufficient processing power is available to meet the increased quantity of rules and facts. With this assumption in mind, it is suggested that an example set of sensors used for ATC operation may comprise: RADAR, high resolution, K-band. The higher resolution RADAR is physically smaller than a longer range S-band RADAR. The reaction times at the estimated 1 nmi range provide adequate processing and vehicle control time, even at a 20 nmi speed. The higher resolution allows better range and track resolution. RADAR is deemed critical for any maritime transit. Energy can be managed by “pinging”, or cycling the RADAR in accordance with SA conditions. For example, in open ocean transit, the RADAR needs infrequent activation. When operating in crowded conditions, the RADAR may require continuous activation.

Another sensor may include 360° EO/IR, which is relatively low cost, in terms of size, weight, power (SWP), but at a higher processing cost. Still, it is deemed helpful for close-in obstacle avoidance. It equates to the mariner's “eyes”. Audio may be required by COLREGS. It is used to detect warning vessel warning signals and intent, as well as fixed warning objects (whistles, bells). It equates to the mariner's “ears”. Another sensor may comprise AIS, particularly for all large tonnage vessels, and is commonly used for smaller vessels as well. For UMV, the transmit function may be disabled, allowing the UMV to receive vessel reports of location, heading, speed and other vessel general information without compromising vehicle position.

Another sensor may include a VHF radio transceiver, which is required by COLREGS. For UMV, it allows the reception of vessel radio-hailing, and allows the UMV to transmit, if desired, its presence as an unmanned vessel. Active AIS can also be used to provide UMV information to other vessels, if deemed appropriate. Local interpretation of voice traffic is deemed to be very difficult, and relay to a shore side operations center is recommended, if sufficient satellite bandwidth is available.

Depending on the specific sensor selection, these outputs may consist of IQ data, raw video or other data types that require follow-on processing to reduce the data set to an understandable “perception”, or contact report. Other sensors, provide concise reports of vessel detections, including heading, speed, position and ancillary information (digestible tracks).

Information from the sensors is provided to the UMV database. Raw data requiring additional processing is provided to the fusion processing function block 72. Fusion processing produces tracks—estimates of vehicle positions, heading and speeds. Fusion processing does not make recommendations based on the generated tracks—its function is to produce and update tracks within the UMV database.

The ATC COLREGS advisor accesses the UMV database, and accepts track information that was produced by the fusion processor, as well as ancillary data including AIS reports, VHF contacts and environmental information. Based on this information, combined with an understanding of COLREGS rules, mission parameters and world map information, and modulated by a mariner's expert knowledge (previously captured as rules), ATC provides a recommendation to the vehicle's primary autonomy controller. These recommendations, depending on the circumstances, may include a course or speed adjustment, VHF hailing, sounding of warning signals, or “stay the course” determination. It is dependent on the primary controller (i.e. operator) to accept or reject these recommendations, and issue appropriate vehicle control commands.

An English language reasoning report is provided from the COLREGS advisor. The report is useful to shore side operations personnel, and for post mission analysis. These reports, as well as other mission feedback (shown in FIG. 4) will be used for rule refinement.

As shown in FIG. 4, an outboard rule wizard application allows for the creation of Jess-compatible rules via a user-friendly interaction. This reduces the need for a Jess-(or other expert system shell) experienced engineer to create appropriate rules. Note that once the expert mariners knowledge is captured in the rules and verified, the required skill level of UMV shore side operators is significantly reduced. The rule wizard is not required for day to day operation of the UMV. The application is only used for initial capture of knowledge, and for the inclusion of additional knowledge as experience is gained, or as new missions are defined. ATC interfaces are supported by a pub/sub interface, a standard Service Oriented Architecture (SOA) construct blocks 74 & 77.

### Applicability of a Rule-Based Expert System

Providing the autonomous systems recommendations described in the previous paragraphs to the vehicle control function based on situational awareness and COLREGS rules, as tempered by a mariner's experience and mission constraints, is ideally suited to the use of a rule-based expert system. It is an enabling technology for a successful surface obstacle avoidance system. Portions of the following explanations were derived from “Jess In Action,” by Ernest Friedman-Hill, the creator of Jess, the contents of which are hereby incorporated by reference in their entirety.

A rule based system is preferred over a signal-processing approach (in line if . . . then . . . else approach) when:
1. A successful algorithm involves significant branching and decision-making, as is true for UMV.
2. Multiple conditions may exist at any given time that affects the decision, as is true for UMV.
3. Decision making conditions change over time. For UMV, the COLREG rules are stable, but other situational awareness factors, such as environmental conditions, mission priorities and location, as well as expert mariner experience, are likely to change the decision making process over time.
4. Rule maintenance over time is required. For UMV, simplified rule maintenance as knowledge is gained over time is a necessary feature. Rule sets are maintained separately in an XML form for user addition, deletion or modification.
5. Processing speed for decision making is not a critical issue. The general purpose expert system architecture is more than adequate for the relatively “slow” situational changes experienced by the UMV.
6. Decision rationale is required. English-language reasoning reports are generated that allow post-mission assessment and rules refinement.
7. Additional autonomous navigation uses are envisioned. The ATC Expert System is also an excellent tool for prototyping, early assessment of performance and training, and could be extended, by the addition of rule modules and database interfaces, to other applications (e.g. sub-surface obstacle avoidance).

### Expert System Selected for ATC

One exemplary implementation of the ATC uses Jess as the selected Expert System. Of course, other expert systems can be used. Jess is a rule-based engine and scripting environment written entirely in Java. With Jess, software can be built that has the capacity to “reason” using rules (COLREGS, expert mariner, mission constraints) that can be repeatedly applied to a collection of facts (world map data, situational awareness, environmental) about the UMV's “world.” Rules that apply are fired, or executed. Jess uses a unique algorithm called Rete to match the rules to the facts. Rete makes Jess more efficient than a simple set of cascading if. then statements in a loop. Jess includes the ability to apply fuzzy logic rules for inference generation. Jess is well-maintained, available at no cost for many applications, and used in hundreds of applications. It uses a typical integrated development environment (Eclipse, Netbeans, other), thereby reducing development complexity and cost.

### ATC Functional Description

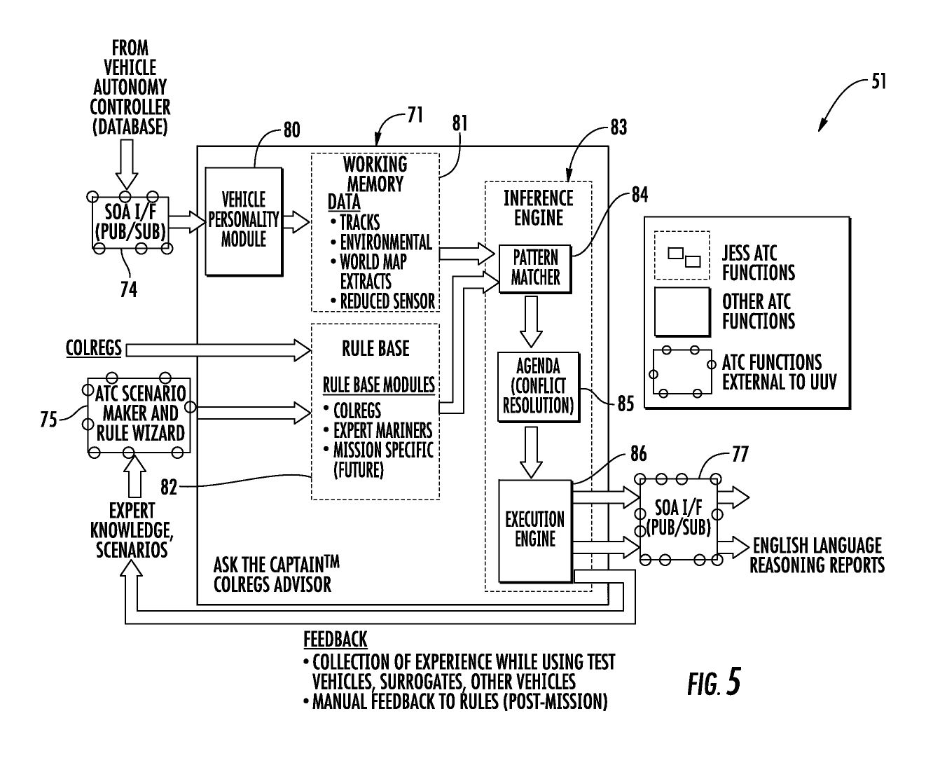

A functional diagram 51 of the ATC 71 is provided in FIG. 5. The Jess shell (dashed lines) comprises:
1. A working memory 81, containing the extracted relevant information from the UMV database.
2. A rule base 82, containing rules segmented in a logical fashion to facilitate creation and maintenance (modules). As shown, there is a set of rules associated solely with corresponding COLREGS rules; a set containing “derived” COLREGS rules, as modulated by an expert (experienced mariners); and task or vehicle specific rules (TTPSs). Additional modules could be added as necessary. For example, a sub-surface module could be included that uses a different set of facts (SONAR vs. RADAR, for example), and would not include the COLREGS surface-oriented rules.
3. An inference engine 83, which applies rules to the set of facts contained within the working memory. The inference engine contains a pattern matcher 84 that selects appropriate rules given the current situation (facts), and activates the rules. Conflicts are resolved, and the rules firing order determined, in the conflict resolver 85. Conflicts are resolved using a priority value (termed the “salience”) associated with each rule. The execution engine 86 fires the set of rules and produces the recommendations and reports.

The vehicle personality module 80 is included as the means to adapt the ATC shell to a specific vehicles database structure and interface requirements. External applications (circle lined boxes) are provided to assist in the definition and capture of rules. The scenario maker application 89 is an interactive tool that allows the creation of scenarios. A domain expert (experienced mariner) can assess the scenarios and recommend a course of action and document a rationale for their decision.

This information can be captured in a transportable rule base using the rule wizard application. Performance feedback (learning) is provided by ATC. This knowledge, in the form of reasoning reports and actual event outcomes, can be used to create and evaluate scenarios based on actual vehicle situations. Rules can be added, deleted, or modified as required to reflect the additional knowledge gained by experience.

### IRAD Version of Scenario Maker Application Rules

Rules are logically grouped in modules that reflect a common thread. For ATC, several modules are planned:
1. Basic COLREGS, reflecting the COLREGS rules
2. Environmental modifiers and rules, related to weather conditions, visibility, time of day, sea state
3. Expert Mariner rules, the rules that tie everything together. The expert mariner considers the COLREGS and environmental conditions when making any decision. ATC emulates this decision making process.
4. Task specific rules, the Tactics, Techniques and Procedures (TTP) of the UMV for a given task (e.g. oil depot protection, open sea interdiction, asset protection).

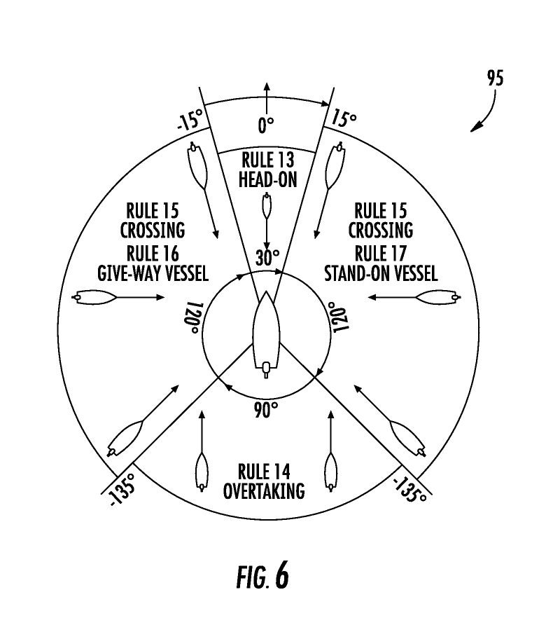

FIG. 6 shows a subset 95 of the COLREGS rules related to collision avoidance, and, at a very top level, the assessment and actions performed by ATC. For example, if the provided SA indicates a vessel is in a “crossing situation,” then rules must be “fired,” and a recommendation made, based on other COLREGS rules. Who is the stand-on vessel? The give-way vessel? What kind of vessel is being considered?

COLREGS does not provide complete guidance. Putting yourself at the helm, as will be done with ATC and the inclusion of an experienced mariners knowledge, functions to clarify the situation. The vessel may be crossing, and may be the stand-on vessel, but is there a danger? Will the vessel's closest point of approach (CPA) infringe on a defined minimum, determined by multiple factors—weather conditions, other vessel traffic, depth constraints, fixed obstacles, speeds? If the assessment deems that action is to be taken, what would the helmsman recommend—based on the previously mentioned, and other criteria?

The simple addition of COLREGS rules is not, by itself, a daunting task. The challenge is adding all the supplemental knowledge of seamanship required to make the correct decision. And, under some conditions, it may be appropriate to “call for help.” In the case of a typical vessel, this would be the helmsman calling the Captain to the bridge. In the case of the UMV, depending on the rules, it may be a “all stop” and a message to the shore controller defining the situation and asking for additional support. Even in this case, knowledge would be gained, archived, and later assessed. The rule sets which led to the indecisive behavior could then be evaluated and updated.

For UMV, the aggregate and interpreted SA provided to ATC may be imprecise, uncertain, ambiguous or probabilistic in nature. A mariner's reasoning frequently involves this type of decision making. For example, RADAR may report contacts, or tracks, that actually don't exist due to clutter. Light patterns may be obscured by weather. Some obstacles may not be universally detected—only a single sensor has “eyes on” the obstacle. It may be difficult to provide an adequate recommendation when using classic set theory and two-valued results—“yes or no”. The human mariner can usually resolve the ambiguities, although the many graphic images of collisions at sea tend to refute this point.

Fuzzy logic will be used by the expert system to emulate the mariner's interpretation of ambiguous information. With fuzzy logic, membership of an element in a set can be partial, with an assigned degree of membership, or possibility. In our missing light case, perhaps only the topmost all round light of a fishing trawler can be seen, and the lower light is obscured. Other SA indicates that a potential fishing vessel with trawl net has been detected, but a 100% classification cannot be made. This interpreted SA can be provided to ATC with a probability qualifier.

ATC accepts this uncertainty, along with all other aggregate and interpreted SA, and provides a recommendation. The recommendation would include a reasoning report that would state the uncertainties in the decision. COLREGS provides rules for lights and shapes, and for sound and light signals. It is currently assumed that the primary autonomy controller interprets the raw sensor data associated with this portion of rules, and produces interpreted SA. This interpretation is conducive to the use of a rule-based expert system.

### ATC Hardware

Jess is an efficient implementation of a rule-based expert system, and is capable of processing several thousand rules per second on low to medium power processors. Ultimately, and since the implementation is platform independent, ATC could be placed within planned UMV processors. During development, and for simplified integration with autonomy controllers, the ATC may be hosted within a compact ruggedized COTS processor from Technologic Systems. The exemplary module is a small (<60 inches³) module, weight is less than 1 lb, and power consumption is less than 5 Watts. The TS-7800 processor is Linux based, and provides fan less operation from −20 deg C. to +70 deg C. The module hosts all the described software: Jess, rule modules, personality module and SOA pub/sub.

### Knowledge Acquisition

Acquiring the knowledge for creation of the rule modules is an important part of the planned effort. As previously noted, external applications (Scenario Maker and Rule Wizard) are provided to assist in the definition and capture of the needed knowledge.

### Summary of Surface Situational Awareness Required for Surface Obstacle Avoidance and Determining Surface Vessel Intent

Typical autonomous solutions utilize multi-spectral information coupled with environmental knowledge, and a world map to create an understanding of the vehicles situation:
1. RADAR provides medium to long range obstacle assessment.
2. LIDAR provides a close-in (low range), precision assessment of obstacles.
3. EO/IR provides a low to medium range assessment/presence of obstacles. Stereoscopic vision can allow some range determination.
4. Audio provides collection of warning bells, whistles and voice hailing.
5. AIS (Automatic Identification System) provides vessel location, heading and other information
6. RF Energy: Extremely sensitive receivers, such as the Harris Extremely Sensitive Receiver (HESR) can collect both intentional and unintentional RF emissions (energy from non-transmitting devices, including RADARs and radios) from vessels for ISR and tracking.

More “eyes” on a target increases confidence of the assessment of the targets intent. The UMV is constrained in SWP, and a reasonable set of sensors must be selected. The gray areas indicate the minimum set of sensors required for satisfying surface autonomy on the UMV, and for ATC to effectively perform its COLREGS advisor function.

For the UMV sensor suite size, weight and power (energy) constraints are significant. There must be balance in the UMV with this set of constraints to allow a realizable solution for the sensor suite, while also complying with COLREGS requirements. The resources need to be managed to minimize energy consumption while at the surface.

Environmental sensors (wind speed, temperature, humidity visibility, sea state) for local weather conditions are included in the recommended sensor suite to support modulation of the ATC rules. For example, operation in restricted visibility dictates a more cautious approach for vessel avoidance. Bearing information, in terms of heading, speed and attitude are also required by ATC. These will be made available via the SOA pub/sub interface.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An unmanned maritime vehicle comprising:
a hull;
a propulsion system carried by said hull;
a plurality of vehicle sensors carried by said hull;
a wireless transceiver carried by said hull; and
a controller coupled to said wireless transceiver, said plurality of vehicle sensors, and said propulsion system;
said controller configured to implement an inference engine and a knowledge base to define an expert system generating a recommended water navigational action based upon a set of water navigational rules and inputs from said plurality of vehicle sensors.

2. The unmanned maritime vehicle of claim 1 wherein said controller is configured to implement the expert system to generate the recommended water navigational action by matching at least one water navigational rule from the set thereof to the inputs from said plurality of vehicle sensors.

3. The unmanned maritime vehicle of claim 1 wherein said controller is configured to implement the expert system to match a plurality of water navigational rules to the inputs of said plurality of vehicle sensors, and resolve conflicts among the matching plurality of water navigational rules to provide the recommended navigational action.

4. The unmanned maritime vehicle of claim 3 wherein each water navigational rule includes a respective priority value; and wherein said controller is configured to implement the expert system to resolve the conflicts among the matching plurality of water navigational rules based upon the respective priority values thereof.

5. The unmanned maritime vehicle of claim 1 wherein said controller is configured to implement the expert system to generate a recommended communication action; and wherein said wireless transceiver is configured to perform the recommend communication action.

6. The unmanned maritime vehicle of claim 1 wherein said controller is configured to implement the expert system to generate the recommended water navigational action based upon a set of task specific rules.

7. The unmanned maritime vehicle of claim 1 wherein said controller is configured to implement the expert system to generate the recommended water navigational action based upon a set of user generated experience rules.

8. The unmanned maritime vehicle of claim 1 wherein said controller is configured to implement the expert system to generate the recommended water navigational action based upon the set of water navigational rules comprising rules based upon International Regulations for Preventing Collisions at Sea 1972 (COLREGS).

9. The unmanned maritime vehicle of claim 1 wherein said controller is configured to implement the expert system to receive the inputs from said plurality of vehicle sensors comprising current and past vehicle sensor data values.

10. The unmanned maritime vehicle of claim 1 wherein said plurality of vehicle sensors comprises at least one of a set of situational awareness sensors.

11. The unmanned maritime vehicle of claim 1 wherein said wireless transceiver is configured to communicate with a command center.

12. An unmanned maritime vehicle comprising:
a hull;
a propulsion system carried by said hull;
a plurality of vehicle sensors carried by said hull;
a wireless transceiver carried by said hull and configured to communicate with a command center; and
a controller coupled to said wireless transceiver, said plurality of vehicle sensors, and said propulsion system;
said controller configured to implement an inference engine and a knowledge base to define an expert system for matching at least one water navigational rule from a set thereof to inputs from said plurality of vehicle sensors, and generating a recommended water navigational action based upon the matching at least one water navigational rule, the set of water navigational rules comprising rules based upon International Regulations for Preventing Collisions at Sea 1972 (COLREGS).

13. The unmanned maritime vehicle of claim 12 wherein said controller is configured to implement the expert system to match a plurality of water navigational rules to the inputs of said plurality of vehicle sensors, and resolve conflicts among the matching plurality of water navigational rules to provide the recommended navigational action.

14. The unmanned maritime vehicle of claim 13 wherein each water navigational rule includes a respective priority value; and wherein said controller is configured to implement the expert system to resolve the conflicts among the matching plurality of water navigational rules based upon the respective priority values thereof.

15. The unmanned maritime vehicle of claim 12 wherein said controller is configured to implement the expert system to generate a recommended communication action; and wherein said wireless transceiver is configured to perform the recommend communication action.

16. The unmanned maritime vehicle of claim 12 wherein said controller is configured to implement the expert system to generate the recommended water navigational action based upon a set of task specific rules.

17. The unmanned maritime vehicle of claim 12 wherein said controller is configured to implement the expert system to generate the recommended water navigational action based upon a set of user generated experience rules.

18. A control unit for an unmanned maritime vehicle comprising a hull, a propulsion system carried by the hull, a plurality of vehicle sensors carried by the hull, and a wireless transceiver carried by the hull, the control unit comprising:
a processor and memory associated therewith and being configured to implement an inference engine and a knowledge base to define an expert system generating a recommended water navigational action based upon a set of water navigational rules and inputs from the plurality of vehicle sensors.

19. The control unit of claim 18 wherein said processor and memory are configured to implement the expert system to generate the recommended water navigational action by matching at least one water navigational rule from the set thereof to the inputs from said plurality of vehicle sensors.

20. The control unit of claim 18 wherein said processor and memory are configured to implement the expert system to match a plurality of water navigational rules to the inputs of said plurality of vehicle sensors, and resolve conflicts among the matching plurality of water navigational rules to provide the recommended navigational action.

21. The control unit of claim 20 wherein each water navigational rule includes a respective priority value; and wherein said processor and memory are configured to implement the expert system to resolve the conflicts among the matching plurality of water navigational rules based upon the respective priority values thereof.

22. A method for operating an unmanned maritime vehicle comprising a hull, a propulsion system carried by the hull, a plurality of vehicle sensors carried by the hull, and a wireless transceiver carried by the hull, the method comprising:
implementing an inference engine and a knowledge base to define an expert system generating a recommended water navigational action based upon a set of water navigational rules and inputs from the plurality of vehicle sensors.

23. The method of claim 22 further comprising generating the recommended water navigational action with the expert system by matching at least one water navigational rule from the set thereof to the inputs from the plurality of vehicle sensors.

24. The method of claim 22 further comprising matching with the expert system a plurality of water navigational rules to the inputs of the plurality of vehicle sensors, and resolving conflicts among the matching plurality of water navigational rules to provide the recommended navigational action.

25. The method of claim 24 wherein each water navigational rule includes a respective priority value; and further comprising resolving with the expert system the conflicts among the matching plurality of water navigational rules based upon the respective priority values thereof.

26. The method of claim 22 further comprising generating with the expert system a recommended communication action, and performing the recommend communication action with the wireless transceiver.

27. The method of claim 22 further comprising generating with the expert system the recommended water navigational action based upon a set of task specific rules.

28. The method of claim 22 further comprising generating with the expert system the recommended water navigational action based upon a set of user generated experience rules.

29. The method of claim 22 further comprising receiving with the expert system the inputs from the plurality of vehicle sensors comprising current and past vehicle sensor data values.
